(19) United States
(12) Patent Application Publication
(10) Pub. No.: US 2014/0348294 A1
(43) Pub. Date: Nov. 27, 2014

(54) METHOD AND DEVICE FOR INSPECTING THE CARGO SPACE OF A TRUCK

(71) Applicant: Smiths Heimann GmbH, Wiesbaden (DE)

(72) Inventors: Michael JECK, Mainz (DE); Patricia SCHALL, Weiterstadt (DE)

(21) Appl. No.: 14/456,535

(22) Filed: Aug. 11, 2014

Related U.S. Application Data
(63) Continuation of application No. PCT/EP2013/052538, filed on Feb. 8, 2013.

(30) Foreign Application Priority Data
Feb. 10, 2012 (DE) 10 2012 002 484.3

(51) Int. Cl. G01V 5/00; G01S 13/58

(52) U.S. Cl. CPC G01V 5/0066; G01V 5/0041; G01V 5/0033; G01S 13/58
USPC 378/57

(57) ABSTRACT

Methods for inspecting the cargo space of a truck in which the truck is moved past an X-ray source that is switched on while the cargo space is being moved past the source and is switched off while the driver's cab is being moved past the source. The truck is irradiated with electromagnetic radiation having a frequency between 1 GHz and 1 THz and the electromagnetic radiation passing through or reflected at the transition between the driver's cab and the cargo space is measured, in order to determine the switch-on time for the X-ray source.

This nonprovisional application is a continuation of International Application No. PCT/EP2013-052538, which was filed on Feb. 8, 2013, and which claims priority to German Patent Application No. 10 2012 002 484.3, which was filed in Germany on Feb. 10, 2012, and which are both herein incorporated by reference.

### BACKGROUND OF THE INVENTION

1. Field of the Invention

The invention concerns a method for inspecting a truck in which the cargo space of the truck is transilluminated with X-rays while the truck is moved past the X- ray source, and also concerns a device for carrying out the method.

2. Description of the Background Art

In order to inspect trucks for suspicious goods (weapons, explosives, smuggled goods, etc.), it is known to use installations without their own conveyor systems in which a driver drives the truck through the inspection system. If cargo containers are transilluminated as the cargo space, then high-energy X-rays with an energy of greater than 1 MeV must be used, which can also penetrate the driver's cab.

To protect the driver, it is therefore necessary to switch off the X-ray source while the driver's cab moves past it. As soon as the driver's cab has moved past, the X-ray source is switched back on in order to transilluminate the cargo space, for example a cargo container, that follows.

In order to identify the transition between the driver's cab and the cargo space, and thus to determine the switch-on time of the X-ray source, optical methods are known which use light curtains. Since the transition region between the driver's cab and the cargo space is increasingly being covered by aerodynamic fairings, it is no longer possible to determine the switch-on position for the X-rays sufficiently precisely with light curtains.

According to another method, a typical length of the driver's cab is assumed, and transillumination with X-rays begins at a fixed distance from the very front of the truck. This method entails the risk that a part of the cargo space is not transilluminated, and thus is not inspected. If the estimated length of the driver's cab is too short, unintended irradiation of the people in the driver's cab may occur.

A method and a device are known from DE 101 22 279 A1, which corresponds to U.S. Pat. No. 7,308,076, and which is incorporated herein by reference. This document describes an X-ray system with a shutter for the X-rays, the opening and closing of which is controlled by means of a bar code reader. For this purpose, a bar code is affixed to the cargo space of each truck to be inspected, which bar code triggers the start of the X-ray inspection by causing the shutter to open. Since bar codes must be affixed to each truck as markers, this method is very time-consuming.

### SUMMARY OF THE INVENTION

It is therefore an object of the invention to provide a method such that a precise and fast distinction is made possible between a truck's driver's cab that is not to be transilluminated and its cargo space that is to be transilluminated.

This object is attained according to an embodiment of the invention in that, in order to determine the switch-on point of the X-ray source, the truck is irradiated with electromagnetic radiation having a frequency between 10 GHz and 1 THz, and the radiation passing through or reflected at the transition between the driver's cab and the cargo space is measured.

In attaining the object, the invention makes use of the circumstance that the driver's cab and the cargo space of a truck generally are bounded by metal walls. In contrast, aerodynamic fairings at the transition between the driver's cab and the cargo space generally are made of plastic-based materials, such as glass fiber reinforced plastics (GFRP), whose reflection behavior, and hence transmission behavior, is different for the electromagnetic radiation employed.

Preferably, radar beams having a frequency between 30 GHz and 300 GHz are used for determining the switch-on point.

Preferably, the speed of a truck passing by is determined by means of an additional radar sensor. In this way, distortions in determining the switch-on point resulting from speed fluctuations can be corrected.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a rough schematic side view of a truck,

FIGS. 2 and 3 show a top view of the principle of operation during transmission operation, and

FIGS. 4 and 5 show the mode of operation during reflection operation.

### DETAILED DESCRIPTION

In FIG. 1, a truck is shown that includes a cargo space 1, a driver's cab 2, and a transition region 3 between the driver's cab 2 and the cargo space 1. The transition region 3 is aerodynamically faired to reduce air resistance. The aerodynamic fairings are made of plastic-based materials, for example glass fiber reinforced plastic (GFRP), which are optically impermeable to electromagnetic radiation in the visible range.

To inspect the truck for suspicious goods (weapons, explosives, smuggled goods, etc.), the truck is moved through an X-ray inspection installation such as is described in DE 101 22 279 A1, for example. The X-ray inspection installation, not shown in the drawing, contains an X-ray source and a detector arrangement aimed at the X-ray source, with a travel lane for the truck located between them. The X-ray source emits X-rays with sufficiently high energy of greater than 1 MeV so that even metal cargo containers can be transilluminated for inspection.

The truck drives through the X-ray inspection system under its own power. Thus, the driver drives the truck along the travel lane between the stationary X-ray source and the stationary detector arrangement and passes by them. To protect the driver, it is necessary for the X-ray source to be switched off while the driver's cab moves past it. Immediately after the driver's cab has passed the radiation area, the X-ray source must be switched on so that even the start of the cargo space is inspected.

To determine the switch-on time of the X-ray source, the truck is irradiated on one side with electromagnetic radiation having a frequency between 1 GHz and 1 THz until the transition region between the driver's cab and the cargo space is detected, and it is thus certain that the driver's cab has passed. For detection, the electromagnetic radiation transmitted or reflected at the transition between the driver's cab and the cargo space is measured. Preferably, the measurement takes place with radar beams having a frequency between 20 GHz and 300 GHz. This radiation can penetrate the plastic material of a fairing, yet components made of metal are impenetrable to it.

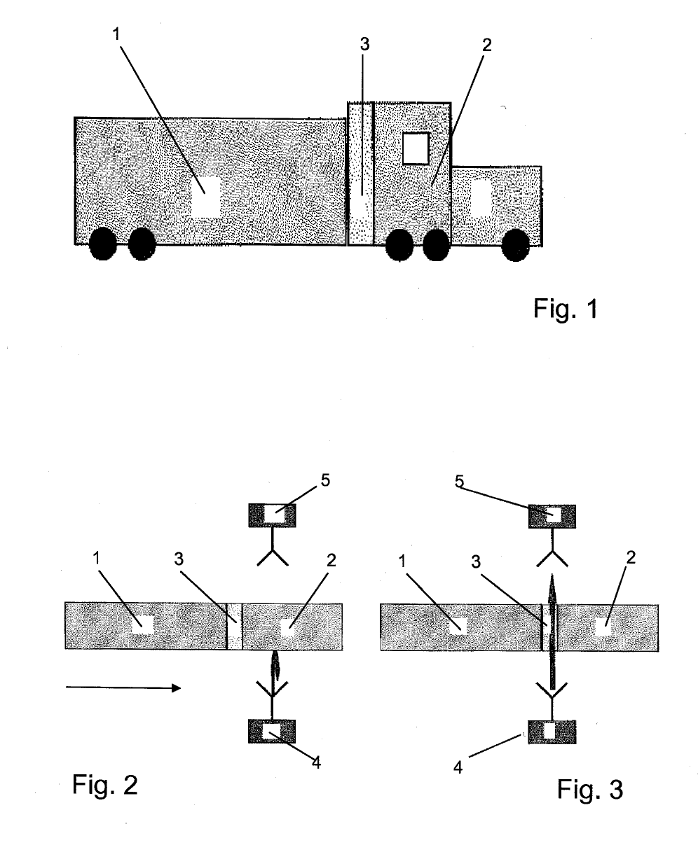

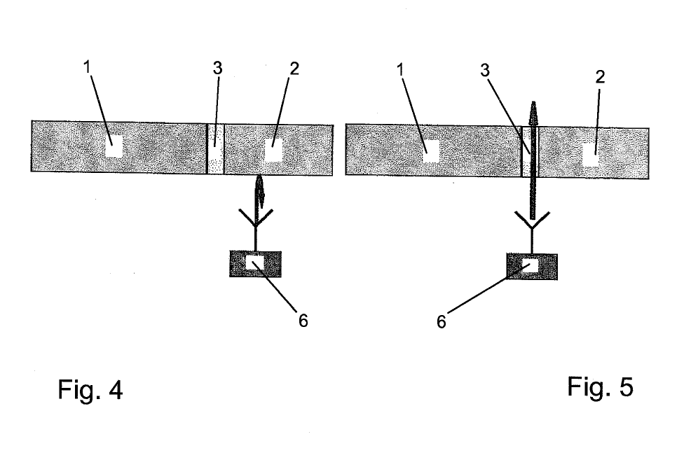

The detection systems in this design are operated either in transmission operation (FIG. 2, FIG. 3) or in reflection operation (FIG. 4, FIG. 5).

In transmission operation, a transmitting unit 4 is arranged on one side of the travel lane. Located on the other side of the travel lane is a receiving unit 5, which is configured to receive transmitted radiation that has passed through the truck and is aimed at the receiving unit 5.

As long as the driver's cab 2 is located between the transmitting unit 4 and the receiving unit 5, the power received by the receiving unit 5 is very low. As soon as the transition region 2 of the truck moves into the radiation region, the received power increases significantly. This increase is a clear sign that the driver's cab 2 has moved past the radiation region, and now the cargo space 1 is entering the beam path of the X-ray source. The X-ray source can thus be switched on to inspect the cargo space 1.

In an installation as shown in FIGS. 4 and 5, which is designed for reflection operation, a transmitting and receiving unit 6 for the electromagnetic radiation is arranged on one side. The received power is high as long as radiation is reflected by the metallic driver's cab 2.

As soon as the transition region between the driver's cab 2 and cargo space 1 enters the beam path, the received reflection power drops significantly. As is shown in FIG. 5, the plastic-based fairing of the truck in the transition region 3 allows the great majority of the radiation to pass through without reflecting it. As soon as the received power subsequently decreases substantially, the X-ray radiation can be switched on, since the driver's cab 2 is no longer located in the beam path of the X-ray radiation.

In order to be able to correct for distortions in receiving the transmitted or reflected electromagnetic radiation caused by speed fluctuations of the truck, an additional radar sensor that determines the speed of the truck traveling past is preferably arranged in the X-ray inspection installation.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for inspecting cargo space of a truck, the method comprising:
moving the truck past an X-ray source that is switched on while the cargo space is being moved past the source and is switched off while a driver's cab of the truck is being moved past the source;
irradiating the truck with electromagnetic radiation having a frequency between 1 GHz and 1 THz; and
measuring the electromagnetic radiation passing through or reflected at the transition between the driver's cab and the cargo space to determine a switch-on point of the X-ray source.

2. The method according to claim 1, wherein radar beams having a frequency between 20 GHz and 300 GHz are used as the electromagnetic radiation.

3. The method according to claim 1, wherein the speed of the truck passing by is determined via a radar sensor.

4. A device for carrying out the method according to claim 1, the device comprising:
at least one X-ray source;
a detector arrangement aimed at the X-ray source, between the detector arrangement and the X-ray source a travel path for a truck is arranged;
a source for electromagnetic beams having a frequency between 10 GHz and 1 THz, is aimed at a truck traveling past, the source being arranged on one side of the travel lane; and
a sensor adapted to receive transmitted or reflected radiation, which is aimed at the source, is located on a same side or an other side of the travel lane.

5. The device according claim 4, wherein the X-ray source emits electromagnetic radiation having a frequency between 20 GHz and 300 GHz.

6. The device according to claim 4, further comprising a radar sensor for determining a speed of a truck passing by.
